(19) United States
(12) Patent Application Publication
(10) Pub. No.: US 2001/0041561 A1
(43) Pub. Date: Nov. 15, 2001

(54) System and method for location-based stimuli motivated information delivery

(76) Inventors: Thomas Ventulett, Atlanta, GA (US); David T. Hardy, Atlanta, GA (US); James K. Leitess, Atlanta, GA (US); Mike Huffaker, Atlanta, GA (US); Doug McNaught, Atlanta, GA (US); Brian Troxell, Kennesaw, GA (US)

Correspondence Address: D. Andrew Floam, NEEDLE & ROSENBERG, P.C., The Candler Building, 127 Peachtree Street, N.E., Suite 1200, Atlanta, GA, 30303-1811, US

(21) Appl. No.: 09/760,026

(22) Filed: Jan. 12, 2001

Related U.S. Application Data
(60) Provisional application No. 60/176,279, filed on Jan. 14, 2000.
(60) Provisional application No. 60/231,179, filed on Sep. 7, 2000.

(51) Int. Cl. H04M 3/42

(52) U.S. Cl. 455/414; 455/566; 455/456

(57) ABSTRACT

A system and method for using a stimulus to motivate from wireless communication devices a request for content for delivery to the wireless communication device or other delivery destinations. A user of a wireless communication device is cued by a stimulus to request content that is related to the source of the stimulus. Computing equipment coupled to the wireless communication network and to the storage device receives requests from the wireless communication device and retrieves content from the storage device that matches a request based on the proximity of the wireless communication device to the stimulus at the time of the request.

This application claims the benefit of U.S. Provisional Application Nos. 60/176,279, filed Jan. 14, 2000 and 60/231,179, filed Sep. 7, 2000, the entirety of which are incorporated herein by reference.

### BACKGROUND OF THE INVENTION

The present invention is directed to a system and method for using a stimulus for motivating the request for transmission from wireless communication devices of content related to the stimulus.

Advertiser marketing has traditionally relied on one-sided intrusive marketing techniques in order to disseminate advertising information to potential customers. Traditional marketing tactics (i.e., mass mailings, e-mail spamming, etc.) have resulted in wasted material resources due in part to advertisements not reaching their intended market. For example, frequently irritated potential consumers ignore the unsolicited marketing advertisement.

Permission marketing is a solution to these marketing problems. Permission marketing presents a marketing model wherein the consumer volunteers to be the recipient of an advertiser's marketing solicitations. A benefit of permission marketing is the conservation of marketing resources.

This invention involves the convergence of the technologies of the Internet, wireless communication devices and stimuli to provide a permission-marketing tool with unlimited potential. The convergence of these media forms a base of enormous potential to inspire mobile users to use the Internet as a source of geographically based advertising information and other content. The stimuli motivate the consumer repeatedly to utilize the technological resources at hand in order to access an advertiser's content.

### SUMMARY OF THE INVENTION

The present invention is directed to a system and method for using stimuli for motivating the request for transmission, from a wireless communication device, of content related to a stimulus wherein in response to the request the content is delivered to the wireless communication device or other destinations. The stimulus may be a sign or other visual marker, and/or audio stimuli, or stimuli with audio and visual characteristics.

The objects, advantages and features of the present invention will become more apparent when reference is made to the following description taken in conjunction with the accompanying drawings.

### BRIEF DESCRIPTION OF THE DRAWINGS

FIG. 1 is a general block diagram of the system architecture according to the invention.

FIG. 2 is a more detailed block diagram that illustrates the primary flows of data in the system.

FIG. 3 is a block diagram which shows the location data flow according to the invention.

FIG. 4 is a flowchart of the geographic location stimuli provisioning process according to the invention.

FIG. 5 is a flowchart of the content provisioning handler process.

FIG. 6 is a diagram that shows a plurality of audio/visual stimuli disposed in a geographic region to illustrate a user's interaction therewith.

FIG. 7 is a pictorial diagram demonstrating a real-time offering of an advertiser's location-based content to a wireless device.

### DETAILED DESCRIPTION OF THE INVENTION

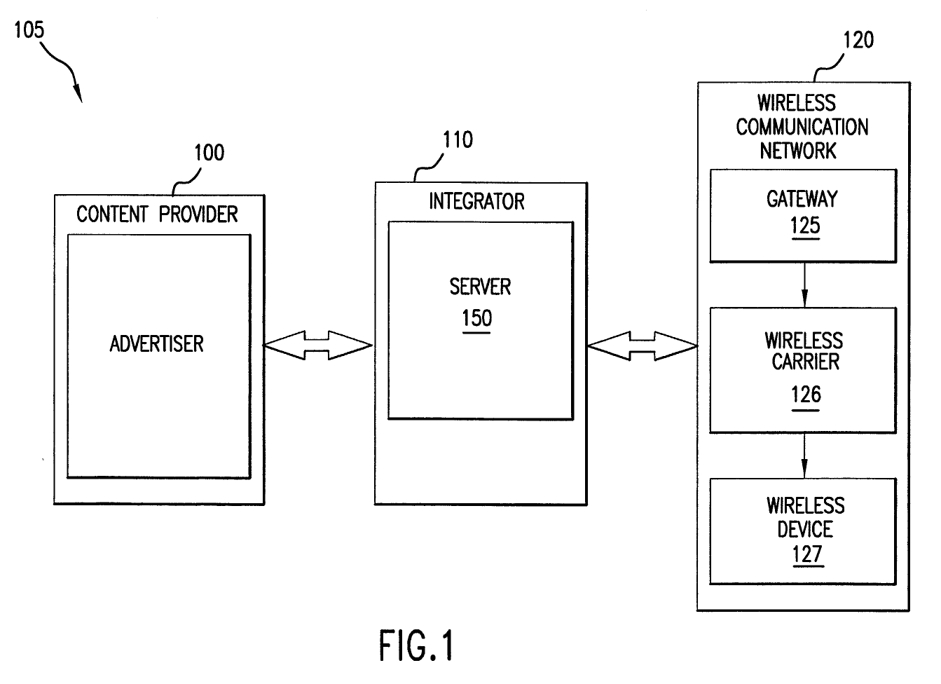

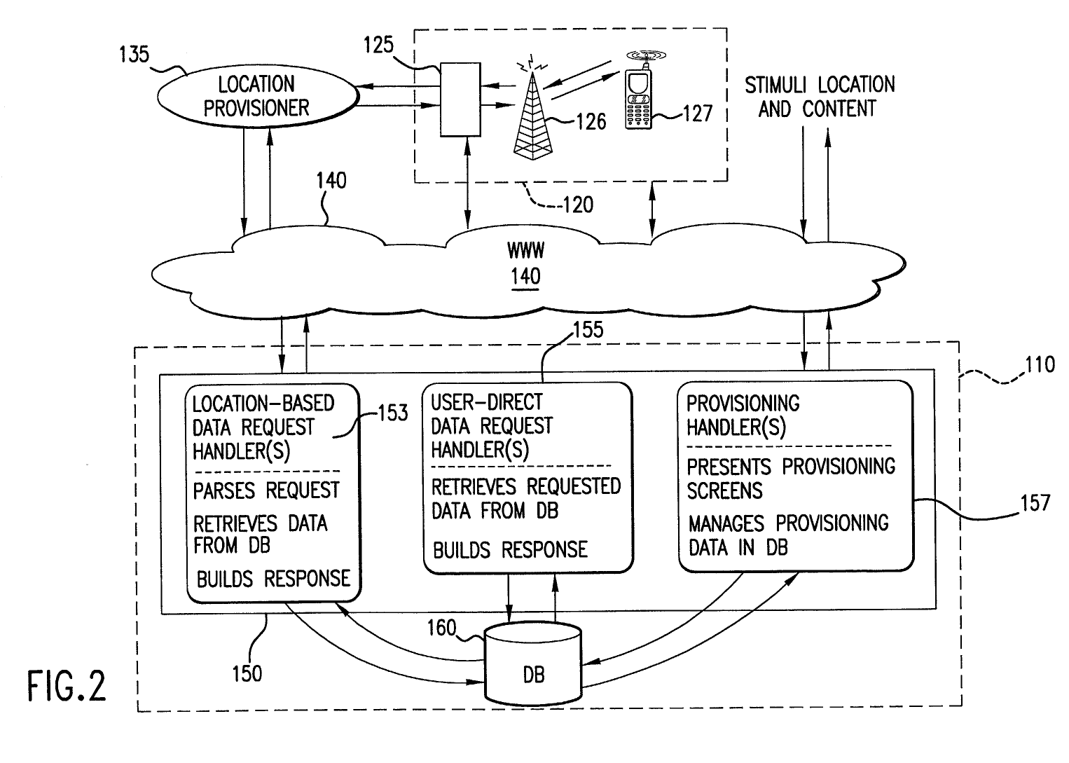

The present invention is described with reference first to FIGS. 1 and 2. Referring to FIG. 1, the content provider 100 represents the advertiser or service client who is the source of the content pertaining to a stimulus. Content is the information that the advertiser or other sponsor of the stimulus wants to present to the consumer or user. Content data may be information regarding the advertiser and the particular nature of their advertisement. There are many types creative incarnations of content that can be offered to the consumer. For example, the content provider 100 can offer special electronic product promotions for the benefit of the consumer or even insert a link that passes a mobile user to the content provider's 100 wireless Internet site.

The content provider 100 is also the source of the geographically placed stimuli whose locations are databased within the system. A sign such as a billboard is an example of a visual stimulus. The stimuli may be any form of advertising that a mobile user can experience in a vehicle or on foot. A visual logo or audio message may be provided to signify that the billboard is a participant in the wireless advertising system. The stimulus is a visual or video stimulus, such a sign or display, or is an audio-based (such as an announcement or musical segment) or has a combination of audio and visual characteristics.

The integrator 110 interfaces between the content provider 100 and the wireless communication network 120. One function of the integrator 110 is the compilation and addition of content stimuli and stimuli locations associated with content providers 100 to the system. The integrator 110 correlates the location of a consumer's wireless communication device 127 with the location of a nearby stimulus.

The wireless communication network 120 comprises a wireless communication device 127, a wireless carrier service provider 126 (e.g., Sprint PCS, AT&T Wireless, etc.) and a wireless access protocol gateway 125. A wireless communication device 127 is provided with mobile two-way communication by way of the wireless carrier 126. Through some means the wireless carrier 126 also provides access for the wireless communication device 1270 to the gateway 125. The gateway 125 serves as a link for the wireless communication device 127 to the Internet or WWW 140. The term wireless communication device is meant to include PC's, laptops, PDAs, hand-held wireless phones, pagers and any other device capable of mobile communication and information presentation.

A user of a wireless communication device 127 initiates a request for content when he/she experiences a stimulus of interest. There are many ways that the wireless communication device may initiate this request for content. This request involves a transmission in the wireless communication network, and for example is accomplished by the user's selection of a text or graphic image (e.g., hyperlinked product name, icon, etc.) that is displayed on a wireless device. For example, the icon that is selected may match an icon that is presented on the stimulus, which alerts the user that a particular stimulus is part of the information delivery system. Other ways to initiate a request for content may include the use of voice recognition technology or the use of hotkey/shortcut key selection. The use of voice recognition technology would allow a wireless communication device 127 operator to simply speak the name of the advertiser/product or other catch term or phrase into the device as a means of initiating a request for content. The use of hotkey/shortcut key selection in order to initiate a request for content would involve the user of the wireless communication device to pressing a key or a series of keys, in a sequence that has been predetermined, on an input keypad of the wireless device. For instance, a consumer comes in contact with a stimulus that serves as an advertisement for a service or product. When a user connects to the wireless communication network with the request for content, her/his geographical location is determined and provided to a server at the time of the request for content from the wireless communication device. Content or a listing of multiple content items associated with the advertiser(s) proximate to the geographical location of the wireless communication device (at the time that the wireless communication device made the request for content) is transmitted for presentation on that wireless communication device, and or to other devices, such as a user's home PC, laptop or other wireless communication devices.

To this end, it is understood the delivery destination of the content is flexible and is managed by the integrator 110. The delivery destination of content may, as a default, be the wireless communication device that requested the initial transmission. However, the integrator 110 also has the capability of allowing a user to establish accounts in which data associated with one or more destination devices is stored to allow the user to select which of the user's devices receive content. For example, a user may wish that all content sent to his/her wireless communication device in response to requests also be sent to a user's email account that the user can access (at some later time) from a home PC or other devices. Moreover, the integrator 110 may also allow new or existing users to transmit messages back from a wireless communication device, which messages contain information identifying other delivery destinations of content that is requested by the user.

The manner in which content is presented to a user of a wireless communication device, or other destination device, includes video display, audio, tactile, or any combination thereof.

The location provisioner 135 interfaces between the wireless carrier 126 and the integrator 110. The location provisioner 135 is known location-determining equipment that is either part of the internal functions of the wireless carrier 126 or is provided by a third-party entity for the wireless carrier. Examples of the location provisioner 135 are products and services provided by Signalsoft, CPS, US Wireless, Snaptrack, etc. The integrator 110 interfaces with the location provisioner 135 to process location-based requests and to perform other functions.

As shown in FIG. 2, the integrator 110 comprises a server or general computing equipment 150 that performs several processes, and database storage 160. The processes shown in FIG. 2 are the: location-based data request handler 153, user direct data handler 155 and provisioning data handler 157.

The user direct data handler 155 processes the transmission of data from the wireless communication device 127 to the server 150 and back to the wireless communication device 127.

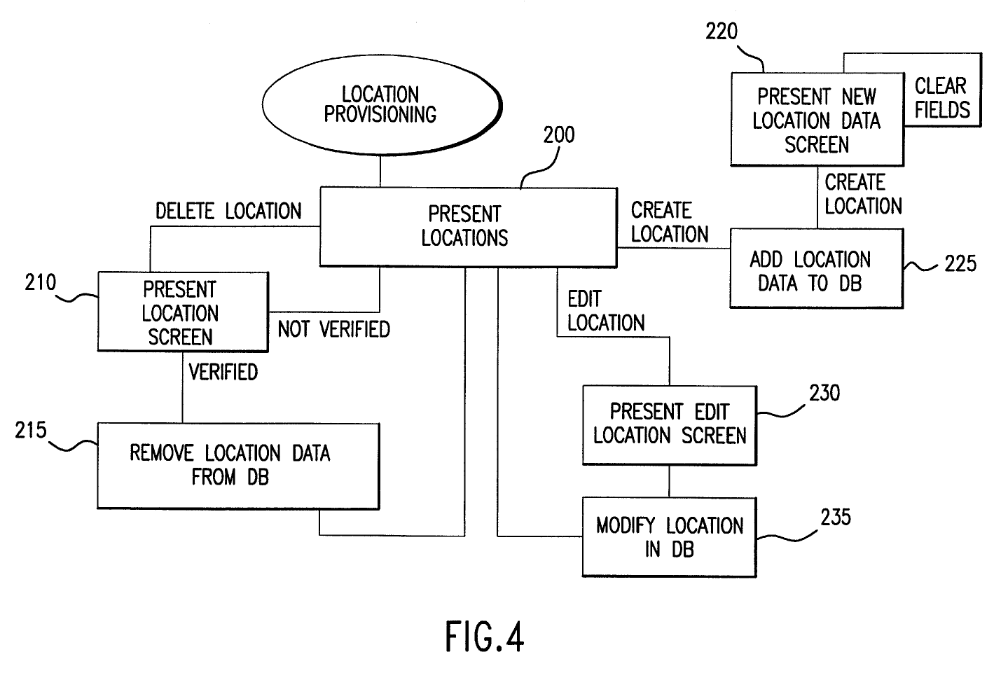

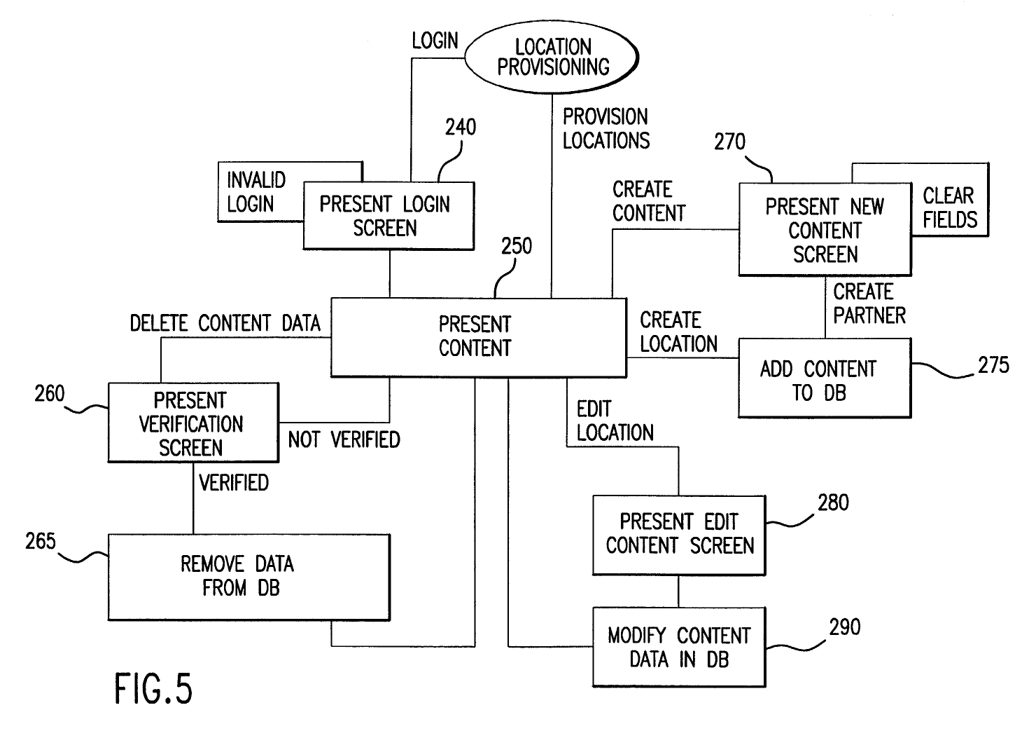

The provisioning data handler 157 allows a client/advertiser to manage on a real-time basis the content an advertiser wishes to provide to consumers. The provisioning handler processes are implemented by way of a set of screens that contain data-entry fields for the acquisition or modification of data that is to be used in the provisioning process as is described hereinafter in more detail in conjunction with FIGS. 4 and 5.

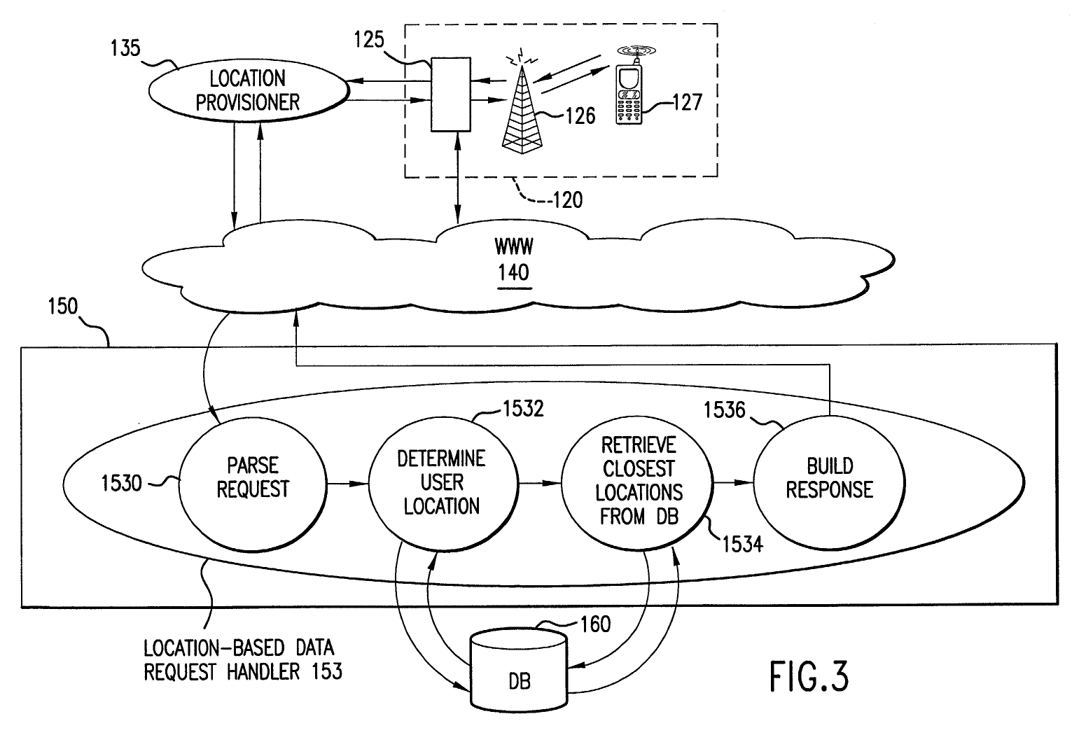

The location data flow 153 will be discussed in reference to FIG. 3. This process has four functions or steps. First, in step 1530 a received request for information from the wireless device is parsed. Next, in step 1532 the location of the wireless device is determined based on information received by the location provisioner 135. In step 1534 the closest advertiser locations from the database 160 are retrieved. Finally, in step 1536, a response is built and dispatched to the wireless communication device and/or other delivery destinations to provide stimuli-related content to the user.

The parsing step 1530 will vary according to the individual location provisioner and according to the protocols that are supported by the browser of the wireless communication device 127. The determination of the location of the wireless communication device 127 from the request may simply involve retrieving the location data from the parsed request. This retrieval process may be as complex as the making of a socket call to a location provisioner 135 in order to obtain the information. Location information may be supplied by the location provisioner in a latitude/longitude pair, or may be supplied in an alternative form such as a street address or postal zip code. The location information utilized by the system may be obtained by way of a GPS or other location determining means used by the location provisioner.

The retrieved content from the database 160 is built into a response and transmitted to the wireless communication device 127 and/or other delivery destinations as described above. Moreover, a set of rules may be provided and managed by the integrator 110 to determine which of several content items are included in a response and in what listing or presentation order of priority, as will be described hereinafter.

Turning now to FIGS. 4 and 5, the provisioning handler 157 of the system is described. FIG. 4 shows the steps of the process for provisioning the geographical locations of the advertiser's stimuli. A screen listing the present locations 200 of stimuli is presented via an interface (e.g., a Web browser interface). When a particular location is selected from the listing, the system administrator or advertiser administrator has the option to perform various functions in regard to the selected listing such as the deletion, creation and modification of stimuli location data.

If the administrator chooses the option of deleting a stimulus location from the database then in step 210 the location screen of the selected location is accordingly displayed. The administrator must verify that this stimulus location's data is to be deleted from the system. If the selection choice is not verified the system returns to the original screen display of the present locations available for selection in step 200. If the selection is verified for deletion then the stimulus location data is removed from the database in step 215 and the screen listing the present stimulus locations in step 200 is again displayed.

A similar process is provided for the creation of new location data for storage in the database. From the present location screen in step 200, the administrator chooses to create database information for a new location. The administrator is taken to a new location data screen in step 220 and then cued to insert information pertaining to the new client into data input fields. A clear fields option is an additional function of this screen. Once the information fields are completed the new location information is added to the database in step 225 and the present locations screen in step 200 is once again displayed. Location information is entered in the form of longitude and latitude or street address and zip code, for example. If automated geographic location means are not available then the information may be obtained and entered into the system by any manual means that is available. This may entail having an individual physically going to location and obtaining the geographic coordinates (using a GPS receiver for example) and subsequently conveying the information back to a system administrator who will then input the coordinates into the system. Alternatively, an individual with a wireless communication device may physically go to each stimulus location and initiate a request for content command at each location which the integrator captures and automatically loads the corresponding location information into its database for the each stimulus.

An editing feature may also be accessed from the present location screen in step 200. A location is selected from the present locations screen in step 200. This location is then displayed on the edit location screen in step 230. In this environment, modifications are made to the location information for a stimulus and the location is consequently modified in the database in step 235. Once this function is complete the present locations screen in step 200 is displayed.

FIG. 5 illustrates the steps of the process of provisioning content. A screen listing the present locations of stimuli is presented in step 250. Once a stimulus is selected from the listing, the system administrator or advertiser administrator has the option to perform various functions in regard to the selected listing. A logon screen 240 is provided to ensure that access to an advertiser's content is restricted to system or advertiser employees authorized to do so.

If the administrator chooses to delete content associated with a stimulus then a verification screen of the selected content is displayed in step 260. Accordingly, the administrator must verify that this content is to be deleted from the system. If the selection chosen is not properly verified the system returns to the original screen display that presents the content available for selection in step 250. If the selection is verified for deletion the content is removed from the database in step 265 and the screen listing the content in step 250 is again displayed.

A system administrator can choose to create and store new content. From the content screen in step 250 the administrator chooses the option to create content. The administrator is taken to a new content screen in step 270 and is cued to input information pertaining to the new content. A clear fields option is an additional function of this screen. Once the information fields are complete then the new content is added to the system's database in step 275 and the present content screen in step 250 is once again displayed. The content can be any combination of data such as text, graphics, video segments and/or audio.

Content to be transmitted to a device may be stored in different formats (or stored in one format and converted into different formats) depending on the delivery destination. For example, if the delivery destination is an email address, then the format for transmission of the content is an email, containing mark-up language data, for example, with a link to a stimulus sponsor's web site or particular promotional pages of a web site.

The editing feature option is accessed from the present content screen in step 250. A content listing is selected for editing. This information is then displayed in the edit content screen in step 280. In this environment modifications can be made and the content is then modified in the database in step 290. Once this function is complete the present content screen in step 250 is displayed.

Content is stored in the database in association with one or more stimuli associated with a particular advertiser or multiple advertisers. For example, an advertiser may have deployed several stimuli and the same or different content may be associated with those stimuli in the database.

The selection of which content to include in a response to a wireless communication device is flexibly controlled by the server 150 (FIG. 2). For example, a wireless device in proximity to several stimuli may send a request for content. The server 150 determines which, if not all, content associated with the proximate stimuli are transmitted to the wireless device according to stored and programmable rules of priority. As an example, an advertiser may pay higher fees to the integrator 110 to obtain preference for the content that is delivered to users. This preference may be in the form of a top or first item to be presented of several content items sent, or perhaps the only content sent item sent during certain times of the day, week, etc. In addition, a region around a stimulus may be set by the server to capture a controllable area of users. Higher fees may be charged to advertisers for a larger area of coverage.

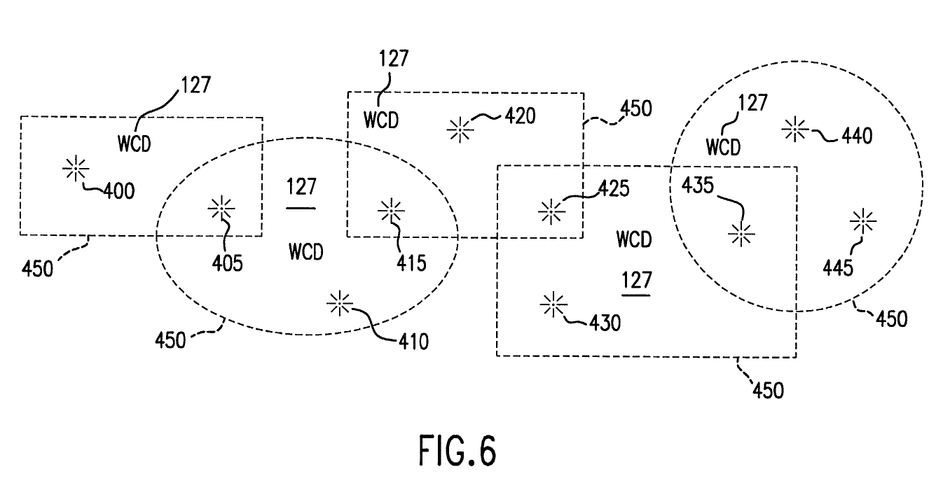

FIG. 6 shows the geographic region 450 that encompasses each of several stimuli 400-445. The wireless communication device 127 must be in proximity to a stimulus in order to receive associated data. As shown, the regions of the varying stimuli may overlap. Due to this overlapping of regions 450, a wireless communication device 127 may receive multiple and different content depending upon the region 450 within which the device is located. The region 450 around or with respect to a stimuli, within which a wireless communication device 127 is located that will trigger the transmission of content, can be of any shape or size and is set by software that resides in the server 150. Moreover, the region 450 may extend in only one direction from the stimuli, as may be the case for a highway billboard sign.

In operation, when the user of the wireless communication device 127 selects or clicks on the displayed visual logo the location of the wireless communication device 127 is delivered to the integrator 110 via device the location provisioner 135. The server 150 correlates the location of a wireless communication device 127 with nearby stimuli. The server 150 retrieves corresponding content from the database 160 and transmits the content back to the gateway 125, which in turn couples the content to the wireless carrier 126 for transmission to the wireless communication device 127. If there are alternative or additional delivery destinations, the integrator transmits content in the appropriate format to those destinations. The transmission of content to the requesting wireless communication device 127 may be substantially contemporaneous with the receipt of the request, or some time later, depending on the particular application and wishes of a stimulus sponsor and/or user.

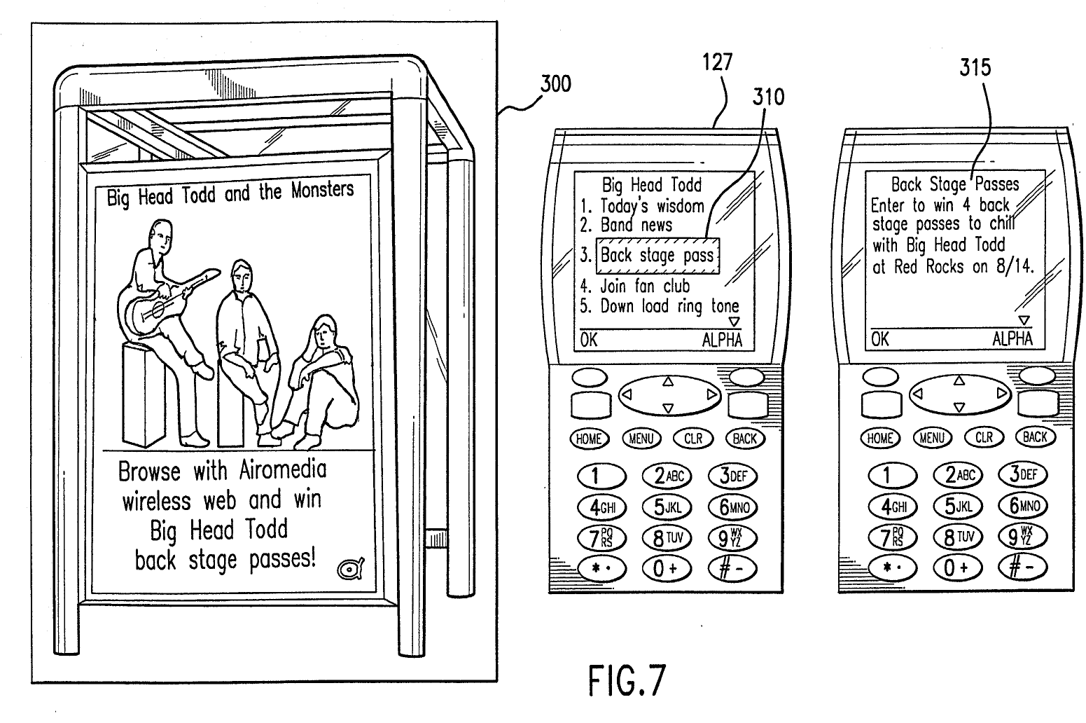

FIG. 7 illustrates an example of what a user operating a wireless communication device 127 within the network's parameters would see on the display of the device when a request is sent at a location proximate stimulus 300. Reference number 310 identifies a screen of content that lists several items associated with the stimulus 300. Reference number 315 identifies a specific screen from the list in screen 310 and is an example of an electronic promotional offer associated with a future event related to the stimulus 300.

As will be recognized by those skilled in the art, the innovative concepts described in the present application can be modified and varied over a wide range of applications. Accordingly, the scope of patented subject matter should not be limited to any of the specific exemplary teachings described herein.

What is claimed is:

1. A system for using stimuli for motivating from wireless communication devices the request for transmission of content, the system comprising:
A) a storage device that stores content pertaining to a plurality of stimuli at various geographic locations; and
B) computing equipment coupled to a wireless communication network and to the storage device that receives a request from a wireless communication device and in response thereto retrieves content from the storage device that matches the request based on the proximity of the wireless communication device to a stimulus for transmission of the content to a delivery destination.

2. The system of claim 1, and further comprising a geographic location provisioner that generates location information of said wireless communication device upon receiving a request for content from said wireless device.

3. The system of claim 2, and further comprising a wireless communication service provider that provides two-way communication with wireless communication devices via the wireless communication network, wherein said geographic location provisioner is part of the wireless communication service provider or is coupled thereto.

4. The system of claim 2, wherein said geographic location provisioner communicates with the wireless communication service provider via the Internet.

5. The system of claim 1, wherein the storage device stores content associated with stimuli positioned at different geographic locations.

6. The system of claim 1, wherein the storage device stores content comprising graphical, text and/or audio information that is related to the stimulus.

7. The system of claim 1, wherein said computing equipment receives information to add, delete or modify location data of one or stimulus.

8. The system of claim 1, wherein the computing equipment receives information to add, delete or modify content pertaining to the at least one audio/visual stimulus.

9. The system of claim 1, wherein the computing equipment generates a message for delivering content via wireless communication to the wireless communication device.

10. The system of claim 1, wherein the computing equipment stores information associated with more than one delivery destination for the content, including email addresses.

11. The system of claim 1, wherein the computing equipment defines the size and or shape of a geographic region with respect to a stimulus for which content is delivered in response to receiving a request from a wireless communication device.

12. A method for using audio/visual stimulus for motivating the transmission of information to wireless communication devices comprising the steps of:
A) positioning at least one stimulus at a geographical location to cue a user to request content that is related to the stimulus;
B) storing content pertaining to the stimulus;
C) receiving a request for content from a wireless communication device;
D) retrieving content that matches the request; and
E) delivering the content to a destination.

13. The method of claim 12, wherein the step of delivering comprises transmitting a message to said wireless communication device.

14. The method of claim 12, wherein the step of delivering comprises transmitting a message to one or more delivery destinations including an email address.

15. The method of claim 12, and further comprising the steps of:
generating location information of said wireless communication device upon receiving a request for content; and
selecting content associated with the stimulus based upon the geographic location of said wireless communication device relative to the geographical location of the stimulus.

16. The method of claim 12, wherein the at least one stimulus cues a user to initiate a request for content transmission function on the wireless communication device.

17. The method of claim 12, where the step of positioning comprises positioning a plurality of stimuli each at a substantially different geographic location, and the step of storing comprises storing content for each of the plurality of stimuli.

18. The method of claim 17, and further comprising adding, deleting or modifying location data for one or more stimuli.

19. The method of claim 17, and further comprising adding, deleting or modifying content for one or more stimuli.

20. The method of claim 15, wherein the step of retrieving content comprises selecting one or more particular content items from among a plurality of content items according to defined rules of priority.

20. The method of claim 20, wherein the step of selecting comprises selecting content associated with a sponsor of a stimulus who has paid greater advertising fees than as compared with sponsors of other stimuli located in proximity to the wireless communication device.

22. The method of claim 12, and further comprising the step of generating a list of content items and designating a presentation order or arrangement of content items based on rules of priority.

23. The method of claim 15, and further comprising the step of defining the size and or shape of the geographic region with respect to a stimulus for which content is delivered in response to a request received from a wireless communication device.

24. A system for using a stimulus for delivering content related to a stimulus, the system comprising:
A) a wireless communication device operable to have two-way communication via a wireless communication network;
B) at least one stimulus that cues a wireless communication device operator to request content that is related to the source of the stimulus;
C) a storage device that stores content relating to the stimulus;
D) computing equipment coupled to the wireless communication network and to the storage device that receives requests from the wireless communication device and retrieves content from the storage device that matches a request for transmission to the wireless communication device based on proximity of the wireless communication device to the stimulus at the time of the request from the wireless communication device.

25. The system of claim 24, wherein the storage device stores content associated with stimuli positioned at different geographic locations.

26. The system of claim 24, wherein the computing equipment stores information associated with more than one delivery destination for the content, including email addresses.

27. The system of claim 24, wherein the computing equipment retrieves content in response to a request according to rules of priority.

28. The system of claim 24, wherein the computing equipment selects content associated with a sponsor of a stimulus who has paid greater advertising fees than as compared with sponsors of other stimuli located in proximity to the wireless communication device.

29. The system of claim 24, wherein the computing equipment generates a list of content items and designates a presentation order or arrangement of content items based on defined rules of priority.

30. The system of claim 24, wherein the computing equipment defines the size and shape of the geographic region with respect to a stimulus for which content is delivered in response to a request received from the wireless communication device.
